(19) United States
(12) Patent Application Publication
(10) Pub. No.: US 2024/0366051 A1
(43) Pub. Date: Nov. 7, 2024

(54) INTELLIGENT ADSORPTION DEVICE AND METHOD FOR GARBAGE

(71) Applicant: ZHONGSHAN RAYTECH ELECTRICAL APPLIANCES CO., LTD., Zhongshan City (CN)

(72) Inventor: HING KIN WILLIAM MA, Hong Kong (CN)

(21) Appl. No.: 18/774,925

(22) Filed: Jul. 17, 2024

(30) Foreign Application Priority Data
Jun. 18, 2024 (CN) 2024107818560

(51) Int. Cl. A47L 9/28; A47L 9/00; A47L 9/02; A47L 9/12

(52) U.S. Cl. CPC A47L 9/2815; A47L 9/0009; A47L 9/02; A47L 9/12; A47L 2201/06

(57) ABSTRACT

The present application discloses an intelligent adsorption device and method for garbage, the device including: a hollow box body and an upper cover covering an upper end of the box body, where an accommodating cavity is formed in a middle portion of the box body, a storage box is inserted in the accommodating cavity, a PCB assembly is disposed at an upper end of the accommodating cavity, and a vacuumizing device and an outer air pipe are communicatively disposed at a lower end of the accommodating cavity. According to the present application, miniature garbage is adsorbed under negative pressure generated by the vacuumizing device, and an operation state of the vacuumizing device is automatically controlled through cooperation with the sensing device, which not only achieve high detection precision, but also obtain a high level of intelligent automation, a simple and compact overall structure, and a good application prospect.

### TECHNICAL FIELD

The present application relates to the technical field of environmental protection equipment, in particular to an intelligent adsorption device and method for garbage.

### BACKGROUND

With the rapid development of science and technologies, current garbage cans gradually iterate in an intelligent direction.

Existing fixed-type intelligent garbage cans can only achieve sensing of humans, that is, sensing of human actions, and then lids are opened. In addition, some moving-type garbage adsorption devices, for example, robot vacuum cleaners and dust collectors, adsorb garbage in a movement manner. However, there is no recognition function in the adsorption process, the intelligence is low, and blockage occurs easily.

In certain situations, for example, a barbershop, the garbage produced there is miniature garbage such as shed hair, dropping points of the garbage are fixed, and reciprocating collection is not needed. However, the conventional fixed-type intelligent garbage cans cannot be used, and the dust collectors have the problem of low intelligence.

On this basis, there is an urgent need for an intelligent adsorption device and method for garbage at present, so as to intelligently adsorb the miniature garbage in the certain situations.

### SUMMARY

In view of the above problems, the present application is put forward to provide an intelligent adsorption device and method for garbage which can solve the above problems or at least partially solve the above problems.

Other characteristics and advantages of the present application will become apparent by means of the detailed description below, or be partially learned by means of the practice of the present application.

According to a first aspect of embodiments of the present application, the intelligent adsorption device for the garbage is provided. The intelligent adsorption device for the garbage comprises: a hollow box body and an upper cover covering an upper end of the box body, where an accommodating cavity is formed in a middle portion of the box body, a storage box is inserted in the accommodating cavity, a PCB assembly is disposed at an upper end of the accommodating cavity, and a vacuumizing device and an outer air pipe are communicatively disposed at a lower end of the accommodating cavity; a lower end of the outer air pipe is in communication with an adsorption port at a bottom of the box body, and an upper end of the outer air pipe is in communication with the storage box; and a function selection module is disposed on the upper cover, a switch assembly is disposed on the box body, a sensing device is disposed on a side of the adsorption port, and the function selection module, the switch assembly, the sensing device and the vacuumizing device are electrically connected to the PCB assembly.

In some embodiments of the present application, the storage box is of a hollow structure, bayonets are disposed at a bottom of the storage box, snap-fitting grooves are formed in positions of a bottom of the accommodating cavity corresponding to the bayonets, and when the storage box is inserted in the accommodating cavity, the bayonets are snap-fitted and fixed to the snap-fitting grooves; and the set number and positions of the snap-fitting grooves correspond to the set number and positions of the bayonets on a one-to-one basis.

In some embodiments of the present application, an outer cover plate is disposed on an outer side of the storage box, and the outer cover plate covers an outer side of the accommodating cavity.

In some embodiments of the present application, an avoidance groove is formed in one side of the box body corresponding to the outer cover plate.

In some embodiments of the present application, a communication hole is formed in a position in the storage box corresponding to the outer air pipe, an inner air pipe is connectively disposed at the communication hole, and the inner air pipe is in communication with the outer air pipe.

In some embodiments of the present application, a first filter port is formed in a position in the storage box corresponding to the vacuumizing device, a filter is disposed at the first filter port, and the filter is in communication with the vacuumizing device; and the first filter port is of a net structure.

In some embodiments of the present application, a second filter port is formed in a position of the box body corresponding to an outlet of the vacuumizing device, and the second filter port is of a net structure.

In some embodiments of the present application, the sensing device comprises an emitter and a receiver, the emitter and the receiver are integrated, and an extension direction of a light source emitted by the emitter directly faces the adsorption port.

In some embodiments of the present application, the light source emitted by the emitter is a light source with a waveband of 940 nm, and a light source received by the receiver is only the light source with the waveband of 940 nm.

According to a second aspect of the embodiments of the present application, the intelligent adsorption method for the garbage is provided, is applied to any intelligent adsorption device for the garbage above, and comprises:
collecting and acquiring, by means of the sensing device, a sensing detection distance and an environmental reflection value corresponding to a position of the adsorption port of the box body;
comparing the sensing detection distance with a maximum detection distance to obtain a distance detection result;
comparing a difference value of the environmental reflection value and a reference value with a detection threshold value to obtain an environmental detection result; and
determining an operation state of the vacuumizing device according to the distance detection result and the environmental detection result, and determining, on the basis of the operation state of the vacuumizing device, whether the garbage at the adsorption port is automatically adsorbed.

The technical solutions provided in the embodiments of the present application at least have the following technical effects or advantages:
according to the intelligent adsorption device and method for the garbage in the embodiments of the present application, miniature garbage is adsorbed under negative pressure generated by the vacuumizing device, and the operation state of the vacuumizing device is automatically controlled through cooperation with the sensing device, which not only achieve high detection precision, but also obtain a high level of intelligent automation, a simple and compact overall structure, a reasonable layout, and a good application prospect.

The above description is only an overview of the technical solutions of the present application. In order to understand the technical means of the present application more clearly, operations can be performed according to the content of the specification. In addition, in order to make the above-mentioned and other purposes, features and advantages of the present application more obvious and easier to understand, the detailed description of the preferred embodiments of the present application is listed below.

### BRIEF DESCRIPTION OF THE DRAWINGS

In order to explain technical solutions of embodiments of the present application more clearly, drawings needed in the embodiments will be briefly introduced below. Obviously, the drawings in the following description are only some embodiments of the present application, and for those of ordinary skill in the art, other drawings can be obtained according to these drawings without involving any inventive effort.

FIG. 1 is an exploded structural schematic diagram of an intelligent adsorption device for garbage provided in an embodiment of the present application;

FIG. 2 is a front sectional schematic diagram of the present application;

FIG. 3 is an axonometric drawing of an intelligent adsorption device for garbage provided in an embodiment of the present application;

FIG. 4 is a lateral sectional schematic diagram of the present invention;

FIG. 5 is a principle diagram of a sensing device; and

FIG. 6 is a flow diagram of an intelligent adsorption method for garbage provided in an embodiment of the present application.

### DESCRIPTION OF REFERENCE NUMERALS

1. storage box; 2. vacuumizing device; 3. box body; 4. upper cover; 5. function selection module; 6. PCB assembly; 7. switch assembly; 8. outer air pipe; 9. sensing device; 10. accommodating cavity; 11. adsorption port; 12. communication hole; 13. first filter port; 14. avoidance groove; 15. filter; 16. second filter port; 17. inner air pipe; 18. bayonet; 19. outer cover plate; and 20. snap-fitting groove.

### DETAILED DESCRIPTION OF EMBODIMENTS

Exemplary embodiments of the present disclosure will be described in more detail with reference to the accompanying drawings below.

Various structural schematic diagrams according to the embodiments of the present disclosure are shown in the accompanying drawings. These drawings are not drawn to scale, for the purpose of clear expression, some details are amplified, and some details may be omitted. The shapes of various regions and layers shown in the drawings and the relative size and position relationships between them are only exemplary, and there may be deviations due to fabrication tolerance or technical restrictions in practice. In addition, a person skilled in the art may additionally design regions/layers with different shapes, sizes and relative positions according to actual needs.

In the context of the present disclosure, when one layer/element is referred to as located “on” the other layer/element, the layer/element may be directly located on the other layer/element, or there may be an intermediate layer/element between them. In addition, if one layer/element is located “on” the other layer/element in a certain direction, when the direction is turned, the layer/element may be located “below” the other layer/element. In the context of the present disclosure, similar or identical components may be indicated by identical or similar reference numerals.

In order to better understand the above technical solutions, the above technical solutions will be explained in detail below in conjunction with particular embodiments. It should be understood that the embodiments in the content of the present disclosure and the specific features in the embodiments are detailed descriptions of the technical solutions of the present application, and are not limitations on the technical solutions of the present application, and the embodiments in the present application and the technical features in the embodiments may be combined under the condition that no conflict exists.

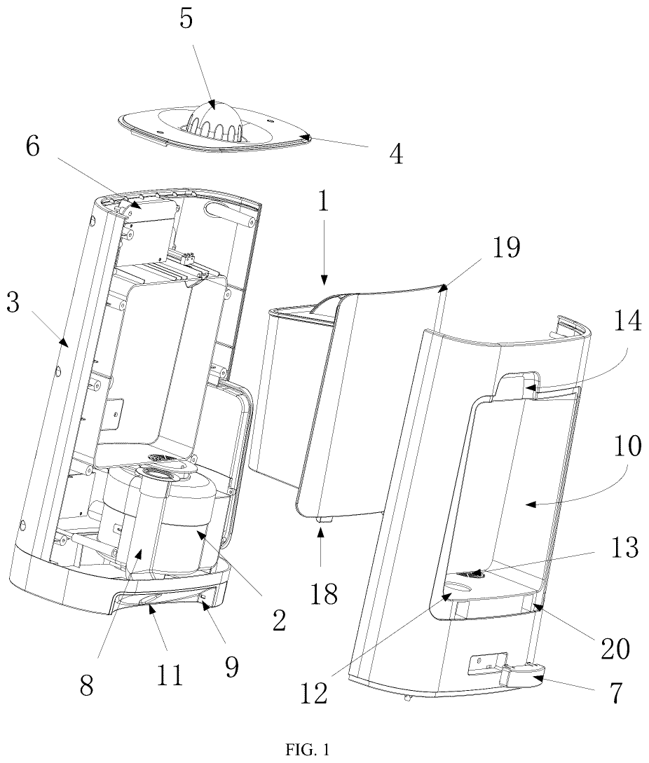

As shown in FIG. 1, an intelligent adsorption device for garbage in the embodiments of the present application is used for adsorbing and recovering dust or miniature garbage (for example, hair) and miniature sundries (for example, paper scraps). The intelligent adsorption device for the garbage includes a hollow box body 3 and an upper cover 4 covering an upper end of the box body 3, where the box body 3 and the upper cover 4 are assembled into a complete outer shell, which is used for providing a physical support and providing a protection effect for various assemblies disposed inside; an accommodating cavity 10 is formed in a middle portion of the box body 3, a storage box 1 is inserted in the accommodating cavity 10, a PCB assembly 6 is disposed at an upper end of the accommodating cavity 10, and a vacuumizing device 2 and an outer air pipe 8 are communicatively disposed at a lower end of the accommodating cavity 10; a lower end of the outer air pipe 8 is in communication with an adsorption port 11 at a bottom of the box body 3, and an upper end of the outer air pipe 8 is in communication with the storage box 1; and a function selection module 5 is disposed on the upper cover 4, a switch assembly 7 is disposed on the box body 3, a sensing device 9 is disposed on a side of the adsorption port 11, and the function selection module 5, the switch assembly 7, the sensing device 9 and the vacuumizing device 2 are electrically connected to the PCB assembly 6.

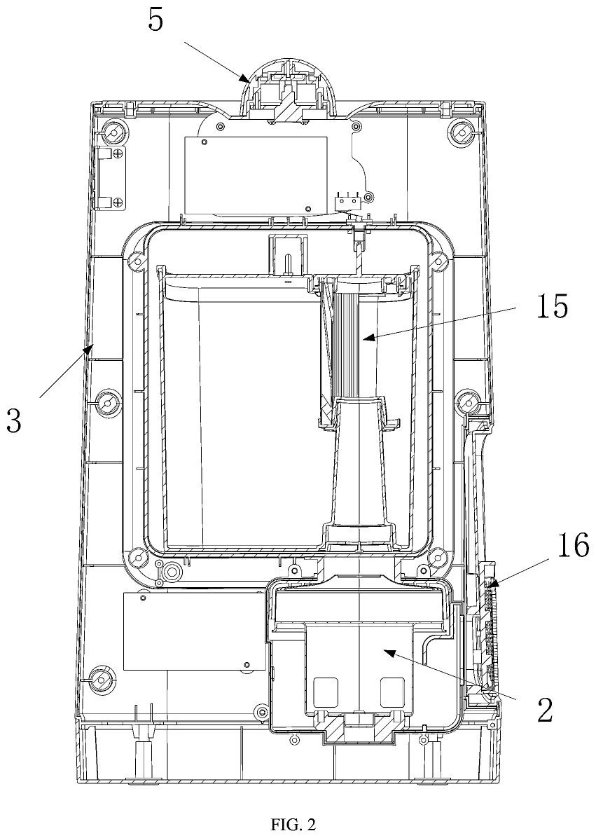

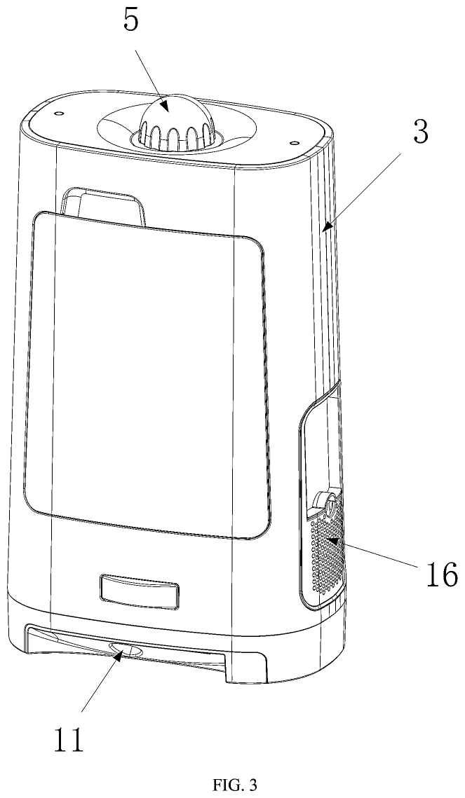

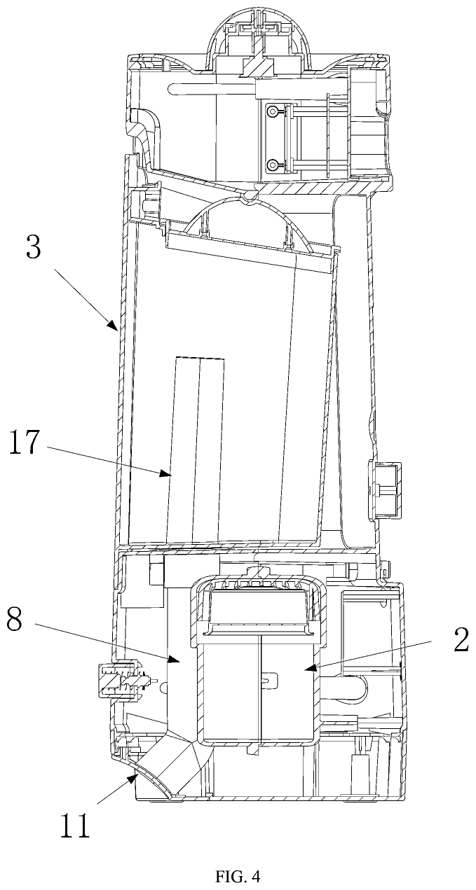

As shown in FIGS. 2-4, in some embodiments of the present application, the storage box 1 is of a hollow structure and is used for storing the adsorbed garbage, bayonets 18 are disposed at a bottom of the storage box 1, snap-fitting grooves 20 are formed in positions of a bottom of the accommodating cavity 10 corresponding to the bayonets 18, and when the storage box 1 is inserted in the accommodating cavity 10, the bayonets 18 are snap-fitted and fixed to the snap-fitting grooves 20; and the set number and positions of the snap-fitting grooves 20 correspond to the set number and positions of the bayonets 18 on a one-to-one basis.

An outer cover plate 19 is disposed on an outer side of the storage box 1, and the outer cover plate 19 covers an outer side of the accommodating cavity 10, thereby closing the accommodating cavity 10, ensuring that the interior of the box body 3 is not interfered by the outside, and improving the airtightness of the overall structure.

In order to conveniently separate the inserted storage box 1 and the box body 3, an avoidance groove 14 is formed in one side of the box body 3 corresponding to the outer cover plate 19; and when the storage box 1 needs to be pulled out, a stress fulcrum may be provided by means of the avoidance groove 14, thereby conveniently separating the storage box 1 and the box body 3.

A communication hole 12 is formed in a position in the storage box 1 corresponding to the outer air pipe 8, an inner air pipe 17 is connectively disposed at the communication hole 12, the inner air pipe 17 is in communication with the outer air pipe 8 and is used for conveying the adsorbed garbage into the storage box 1, and the inner air pipe 17 has the effect of preventing the adsorbed garbage from directly falling back to the adsorption port 11 through the communication hole 12 when the vacuumizing device 2 stops operation.

A first filter port 13 is formed in a position in the storage box 1 corresponding to the vacuumizing device 2, a filter 15 is disposed at the first filter port 13, and the filter 15 is in communication with the vacuumizing device 2 and is used for preventing the garbage from being extracted out of the storage box 1 along with an air force when the vacuumizing device 2 generates the negative-pressure air force; and the first filter port 13 is of a net structure and may have a certain filtering effect.

A second filter port 16 is formed in a position of the box body 3 corresponding to an outlet of the vacuumizing device 2, and the second filter port 16 is of a net structure and may have a further filtering effect.

In the present application, the sensing device 9 includes an emitter and a receiver, the emitter is used for emitting a light source, the receiver is used for receiving the reflected light source, and an extension direction of the light source emitted by the emitter directly faces the adsorption port 11; and in order to improve the accuracy of sensing recognition and avoid external interference, the light source emitted by the emitter is a light source with a waveband of 940 nm, and the light source received by the receiver is only the light source with the waveband of 940 nm.

In the present application, the emitter and the receiver are integrated; in other embodiments, the emitter and the receiver may also be disposed independently; and the disposing manner may be selected by a use on the basis of the actual application needs, and is not limited in the present application.

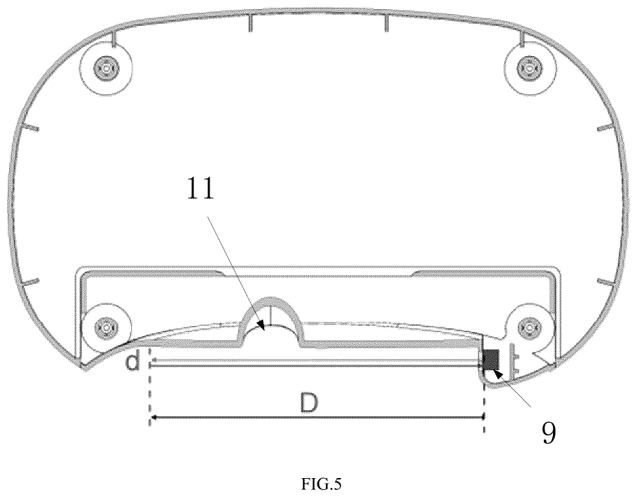

As shown in FIG. 5, a maximum detection distance of the emitter is D, a sensing detection distance obtained by detection of a position of the garbage is d, the sensing detection distance is compared with the maximum detection distance to obtain a distance detection result, and if the distance detection result is d≤D, the sensing device 9 feeds back a signal to the PCB assembly 6 and correspondingly controls the vacuumizing device 2 to start so as to adsorb the detected garbage. It should be noted that if the distance between the position of the garbage and the sensing device 9 is greater than D, the sensing device 9 cannot perform sensing, then it can be assumed that the garbage is not an object to be adsorbed, and the vacuumizing device 2 is not started.

In the present application, the sensing device 9 is further used for collecting and acquiring, when the switch assembly 7 is started for the first time (in an initial state), an initial environmental reflection value corresponding to the position of the adsorption port 11 to serve as a reference value, the environmental reflection value represents a reflection state at the position of the adsorption port 11, when the switch assembly 7 is in an on state later, on the basis of the detection of the position of the adsorption port 11, if the garbage exists, the environmental reflection value corresponding to the position of the adsorption port 11 may be changed, and a newly acquired environmental reflection value is compared with the reference value to determine whether the garbage exists. Of course, it should be noted that in order to avoid detection errors, in the present application, the range of a detection threshold value is determined according to the actual needs, a difference value of the environmental reflection value and the reference value is compared with the detection threshold value to obtain an environmental detection result, that is, when the difference value of the acquired environmental reflection value and the reference value is not less than the detection threshold value, the environmental detection result represents existing of the garbage, otherwise, the environmental detection result represents no garbage; for example, when the reference value is B, the determined range of the detection threshold value is 500, and the acquired environmental reflection value b≥B+500, it is assumed that the environmental detection result represents existing of the garbage, and if the acquired environmental reflection value b<B+500, it is assumed that the environmental detection result represents no garbage; and when the acquired environmental reflection value b≥B+500, after a preset period of time, if the acquired environmental reflection value is not changed, then it can be assumed that the adsorption port 11 is blocked, and adsorption needs to be stopped. By means of the detection of the environmental reflection value by the sensing device 9, in the present application, whether the adsorption port 11 is blocked can be confirmed by detecting the environmental reflection value, thereby achieving quick response and timely solving the problem.

The PCB assembly 6 includes a processor and corresponding functional assemblies, and is used for providing a basic logical judgment function and a communication transmission function.

The function selection module 5 and the switch assembly 7 are respectively used for function selection and on-off control, and achieve the function selection or the on-off control by means of functions of physical switches; for example, the function selection module 5 performs the function selection by means of a knob structure, including function switching of a manual on-off mode or an automatic on-off mode of garbage adsorption, if the automatic on-off mode is selected, the vacuumizing device 2 and the sensing device 9 may operate automatically, and if the manual on-off mode is selected, the switch assembly 7 needs to be started manually to perform the garbage adsorption; and for example, the switch assembly 7 controls operation of the vacuumizing device 2 by means of a button structure, and performs manual powering-on or powering-off.

The intelligent adsorption device for the garbage in the embodiments of the present application collects and acquires, by means of the sensing device 9, the sensing detection distance and the environmental reflection value corresponding to the position of the adsorption port 11 of the box body 3, compares the sensing detection distance with the maximum detection distance to obtain the distance detection result, compares the difference value of the environmental reflection value and the reference value with the detection threshold value to obtain the environmental detection result, determines the operation state of the vacuumizing device 2 according to the distance detection result and the environmental detection result, and determines, on the basis of the operation state of the vacuumizing device 2, whether the garbage at the adsorption port 11 is automatically adsorbed. Miniature garbage is adsorbed under negative pressure generated by the vacuumizing device 2, and the operation state of the vacuumizing device 2 is automatically controlled through cooperation with the sensing device 9, which not only achieve high detection precision, but also obtain a high level of intelligent automation, a simple and compact overall structure, a reasonable layout, and a good application prospect.

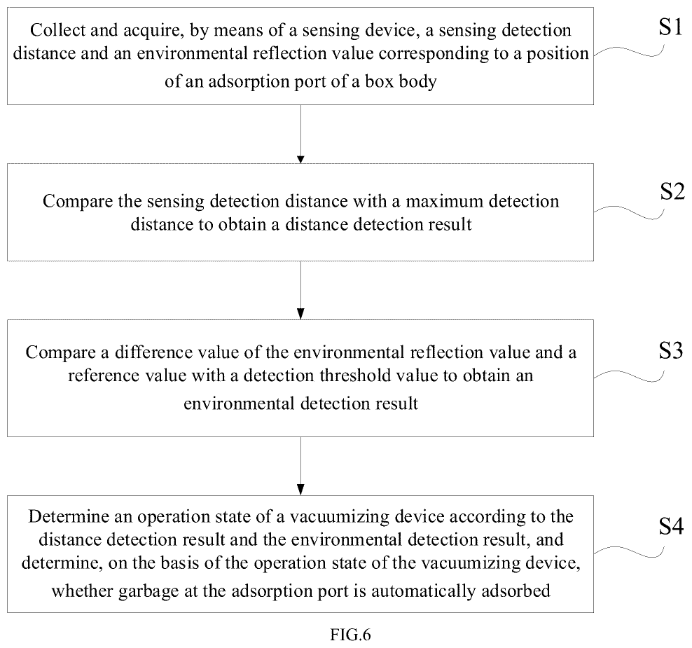

On the basis of the above embodiments, as the implementation of the device as shown in FIG. 1, the present application provides an intelligent adsorption method for garbage. The embodiment of the method corresponds to the embodiment of the device as shown in FIG. 1. As shown in FIG. 6, the intelligent adsorption method for the garbage includes the following steps:
S1. collecting and acquiring, by means of the sensing device, the sensing detection distance and the environmental reflection value corresponding to the position of the adsorption port of the box body;
S2. comparing the sensing detection distance with the maximum detection distance to obtain the distance detection result;
S3. comparing the difference value of the environmental reflection value and the reference value with the detection threshold value to obtain the environmental detection result; and
S4. determining the operation state of the vacuumizing device according to the distance detection result and the environmental detection result, and determining, on the basis of the operation state of the vacuumizing device, whether the garbage at the adsorption port is automatically adsorbed.

The intelligent adsorption method for the garbage in the embodiment of the present application can be executed by the intelligent adsorption device for the garbage provided in the above embodiments, and the intelligent adsorption method for the garbage has the corresponding function modules and beneficial effects of the intelligent adsorption device for the garbage in the above embodiments, which can be seen from the embodiments of the intelligent adsorption device for the garbage for details, and are not repeated in the embodiment of the present application.

A lot of specific details are illustrated in the specification provided here. However, it can be understood that the embodiments of the present application may be practiced without these specific details. In some examples, well-known methods, structures and techniques are not shown in detail, thereby avoiding blurring of the understanding of the specification.

Similarly, it should be understood that in order to simplify the present disclosure and help understand one or more aspects of the application, in the above descriptions of the exemplary embodiments of the present application, the features of the present application are sometimes grouped into the single embodiment, drawing or the description thereof. However, the method in the disclosure should not be explained to reflect the following intent: the present application claims more features than the features explicitly recited in each claim. More exactly, as reflected in the claims, the aspects of the application have fewer features than all the features of the previously disclosed single embodiment. Therefore, the claims that follow the particular embodiments are explicitly incorporated into the particular embodiments, and each claim itself serves as an individual embodiment of the present application.

It should be noted that the above embodiments are intended to explain the present application instead of limiting the present application, and a person skilled in the art may design alternative embodiments without departing from the scope of the appended claims.

1. An intelligent adsorption device for garbage, comprising: a hollow box body and an upper cover covering an upper end of the box body, wherein an accommodating cavity is formed in a middle portion of the box body, a storage box is inserted in the accommodating cavity, a PCB assembly is disposed at an upper end of the accommodating cavity, and a vacuumizing device and an outer air pipe are communicatively disposed at a lower end of the accommodating cavity; a lower end of the outer air pipe is in communication with an adsorption port at a bottom of the box body, and an upper end of the outer air pipe is in communication with the storage box; and a function selection module is disposed on the upper cover, a switch assembly is disposed on the box body, a sensing device is disposed on a side of the adsorption port, and the function selection module, the switch assembly, the sensing device and the vacuumizing device are electrically connected to the PCB assembly.

2. The intelligent adsorption device for garbage according to claim 1, wherein the storage box is of a hollow structure, bayonets are disposed at a bottom of the storage box, snap-fitting grooves are formed in positions of a bottom of the accommodating cavity corresponding to the bayonets, and when the storage box is inserted in the accommodating cavity, the bayonets are snap-fitted and fixed to the snap-fitting grooves; and the set number and positions of the snap-fitting grooves correspond to the set number and positions of the bayonets on a one-to-one basis.

3. The intelligent adsorption device for garbage according to claim 1, wherein an outer cover plate is disposed on an outer side of the storage box, and the outer cover plate covers an outer side of the accommodating cavity.

4. The intelligent adsorption device for garbage according to claim 3, wherein an avoidance groove is formed in one side of the box body corresponding to the outer cover plate.

5. The intelligent adsorption device for garbage according to claim 1, wherein a communication hole is formed in a position in the storage box corresponding to the outer air pipe, an inner air pipe is connectively disposed at the communication hole, and the inner air pipe is in communication with the outer air pipe.

6. The intelligent adsorption device for garbage according to claim 1, wherein a first filter port is formed in a position in the storage box corresponding to the vacuumizing device, a filter is disposed at the first filter port, and the filter is in communication with the vacuumizing device; and the first filter port is of a net structure.

7. The intelligent adsorption device for garbage according to claim 1, wherein a second filter port is formed in a position of the box body corresponding to an outlet of the vacuumizing device, and the second filter port is of a net structure.

8. The intelligent adsorption device for garbage according to claim 1, wherein the sensing device comprises an emitter and a receiver, the emitter and the receiver are integrated, and an extension direction of a light source emitted by the emitter directly faces the adsorption port.

9. The intelligent adsorption device for garbage according to claim 8, wherein the light source emitted by the emitter is a light source with a waveband of 940 nm, and a light source received by the receiver is only the light source with the waveband of 940 nm.

10. An intelligent adsorption method for garbage, applied to the intelligent adsorption device for garbage according to claim 1, comprising:
collecting and acquiring, by means of the sensing device, a sensing detection distance and an environmental reflection value corresponding to a position of the adsorption port of the box body;
comparing the sensing detection distance with a maximum detection distance to obtain a distance detection result;
comparing a difference value of the environmental reflection value and a reference value with a detection threshold value to obtain an environmental detection result; and
determining an operation state of the vacuumizing device according to the distance detection result and the environmental detection result, and determining, on the basis of the operation state of the vacuumizing device, whether the garbage at the adsorption port is automatically adsorbed.
